(19) United States
(12) Patent Application Publication
(10) Pub. No.: US 2008/0109866 A1
(43) Pub. Date: May 8, 2008

(54) Context based secure sharing and voice and video communication on a television

(75) Inventors: Renjit Tom Thomas, Vancouver, WA (US); George Rome Borden, Portland, OR (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/592,892

(22) Filed: Nov. 3, 2006

(51) Int. Cl. H04N 7/16

(52) U.S. Cl. 725/139

(57) ABSTRACT

A system is disclosed for providing context-based sharing of TV input data over a secure communications link via the Internet. Data, such as image, music and video files and metadata, related directly to the media currently displayed on the television set by way of a broadcast medium may be captured and shared with peer users. This feature may be integral to the television set and it may be controlled by the television set's remote control.

### CROSS-REFERENCE TO RELATED APPLICATIONS

Not applicable.

### BACKGROUND OF THE INVENTION

Televisions can be connected to the Internet using a network cable or a wireless connection. Thus, televisions are capable of communication through the Internet, and this enables televisions with features such e-mail or instant messaging. In many configurations a set-top box interconnected between the television and the Internet facilitates the Internet connectivity. In this configuration, the television is used as a display device for the set top box.

Some televisions include integral Internet connecting capability. For example, publication WO 0060849 (“Method and Apparatus for Internet Access through a Television Set”) discloses circuitry and software for accessing the Internet by a television. U.S. Pat. No. 6,151,077, discloses a circuit for providing an integrated mail system for a television.

However no system shares data through the Internet that is contextually related to media provided on the television.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a block schematic diagram of the overall system configuration.

FIG. 2 is a block schematic diagram of the TV set of FIG. 1.

FIG. 3 is an illustration of a TV monitor displaying a voice-mail message from a sharing service provider.

FIG. 4 is a representation of the screen of a TV monitor displaying a communications interface for context sharing of a television program.

FIG. 5 is a representation of a graphical interface for sharing content displayed on a television screen.

FIG. 6 is a pictorial representation of a television screen having a graphical interface for sharing a voice-mail message.

FIG. 7 is a graphical interface for a radio service displayed on a TV screen.

FIG. 8 is a pictorial representation of a graphical interface for sharing radio content selected by the interface shown in FIG. 7.

FIG. 9 is a schematic representation of the structure of a general-purpose JPEG header.

FIG. 10 is a schematic representation of the design of an information header for a data packet.

FIG. 11 illustrates a header to facilitate a broadcast encryption method.

FIG. 12 is a schematic representation of the retrieval of an encrypted message.

### DETAILED DESCRIPTION OF PREFERRED EMBODIMENT

A system for sharing context-derived data over the Internet includes a television capable of displaying image data in multiple windows and a digital data processing module having bidirectional connectivity to a data provider. The television includes a receiver that receives content, which may include for example video, audio, images, radio, music, and/or computer based content. A context-recognition module is connected to the receiver to determine the nature of the content being displayed on the television. An interface generator is interconnected between the context-recognition module and the display to provide a graphical user interface on the television in a display window. The graphical user interface being displayed has control functions that correspond with the nature of the content being displayed.

A remote control device is used to interact with the user interface which provides control functionality. The user interface may capture images currently being displayed on the television as media data which may be saved to a storage medium. The control functions may include sending of media data to peer users, that is, other users that may receive data from the user. The communication between users may be a communication link that is with or without data encryption. Other control functions may include voice inputs, image inputs, video inputs, and/or audio inputs, which likewise may be saved to the storage medium as media data. A security-encoding module may be used to encode the media data prior to its transmission between users.

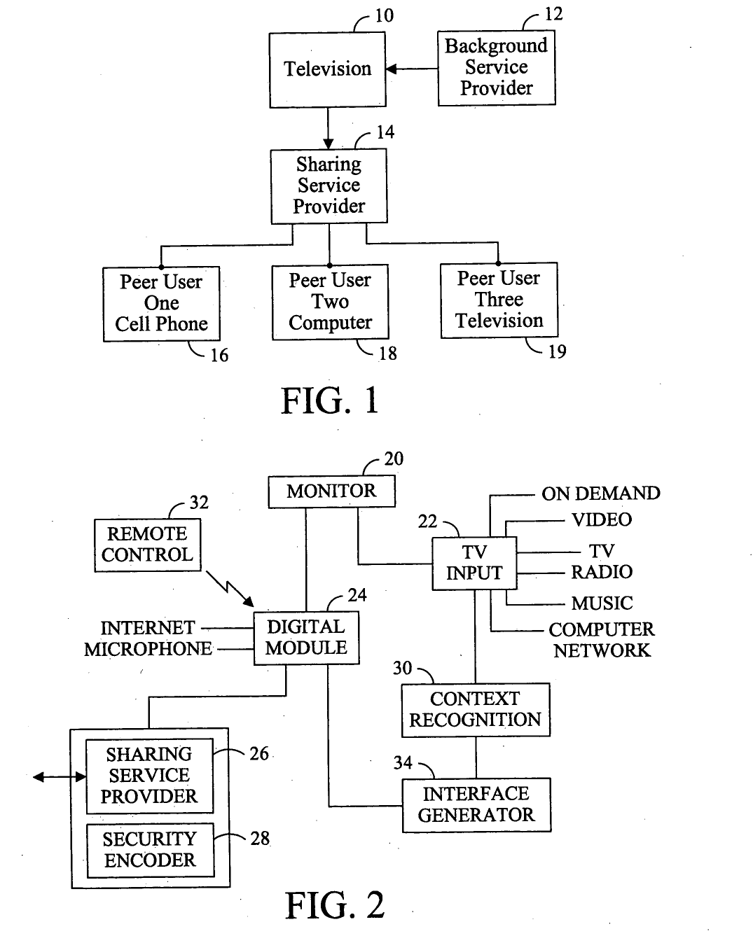

Referring to FIG. 1, a television 10 is connected to a background service provider 12. The background service provider may be a cable company, a Dish™ network, a broadcast television provider, an over-the-air radio station, a music-on-demand service, an IP based service provider (e.g., AOL), or other content provider providing or otherwise making available content by any transmission mechanism. Some transmission mechanisms include cable, over-the-air broadcasts, computer networks, and/or the Internet. The television 10 is coupled to a sharing-service provider 14. The sharing-service provider 14 is a service that allows for peer-to-peer or client-server communication by way of any suitable medium such as e-mail, voicemail, instant messaging, or other communication mechanism. For example, in FIG. 1, the sharing-service provider 14 may be connected to three peer users. Peer user one 16 is a user communicating with the sharing-service provider 14 using a mobile phone. Peer user two 18 is a user communicating with the sharing-service provider 14 using a computer. Peer user three 19 is a user communicating with the sharing-service provider 14 using his television.

Referring now to FIG. 2, the television system may include a monitor 20. The monitor 20 may have standard audio, video, and data inputs 22. The inputs 22 provide suitable interconnection for different media providers or content sources. For example as shown in FIG. 2, the inputs may include “on demand” television, broadcast video, radio, computer network based services, and/or a music service. The system includes a digital module 24 which is interconnected to the Internet and may include a microphone input. The digital module 24 is connected to a bidirectional sharing-service provider 26. This module is similar to the sharing-service provider 14 shown in FIG. 1 but also includes a security encoder 28. A context-recognition module 30 is connected to the television input 22. The context-recognition module 30 is also connected to the digital module 24 that, in turn, is controlled by the remote control 32. An interface generator 34 is coupled between the context-recognition module 30 and the digital module 24.

To facilitate external communication, users may authenticate with a service provider, such as the service provider 14 illustrated in FIG. 1. The service provider 14 may provide many different services, such as for example, a photo service, a radio service, and a voice message board (which involves capturing voice from the television viewer using an integrated microphone). Given the context and nature of any of the services provided by the service provider 14, the user can use a desirable function to facilitate the sharing of files and/or data.

For example, while the user is using the photo service provided by the service provider 14, the user can capture a screen shot from live television (e.g., video), share it with friends, upload the image to a private account, upload the image to a public folder for everybody to view, upload the image to a private folder for only the user, or upload the image to a semi-public folder for selected people to view.

For example, while the user is using the audio message board service provided by the service provider 14, the user can record a voice mail, share the voicemail with friends, upload the voice mail to a private account, upload the voice mail to a public folder for everyone to listen to, upload the voice mail to a private folder for only the user, or upload the voice mail to a semi-public folder for selected people to listen to.

For example, while the user is using the radio service or music/video on demand service provided by the service provider 14 the user can alert his friends about the metadata that comes in the radio/audio/video stream, upload the metadata to a private account, upload the metadata to a public folder for everyone to obtain, upload the metadata to a private folder for only the user, or upload the metadata to a semi-public folder for selected people to view.

Thus, in the context of the illustrative three services described above, sharing implies sending the metadata (e.g., information on the artist or station, purchase information about the CD/track etc) or files to friends. For any suitable service, the media or metadata (relevant to the service being used), can be sent/shared with other users.

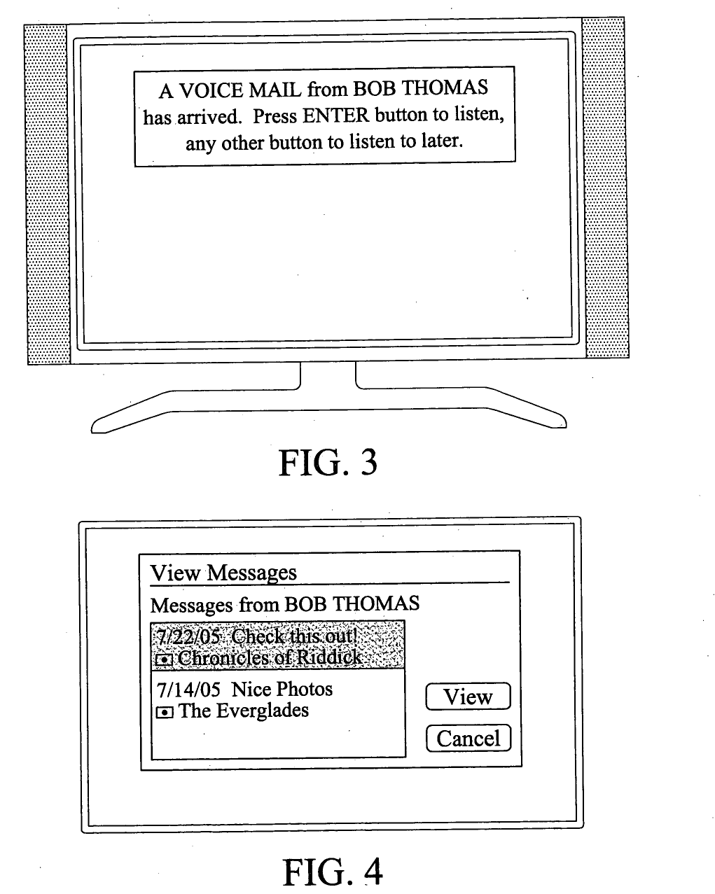

When information or media is shared with a peer friend, the friend should be alerted in a non-intrusive manner on the television, as illustrated in FIG. 3. If the user desires, he can view and/or reply to the message as shown in FIG. 4; or he can chose to ignore it or respond to it later. Additionally, the user may turn off the alerting service.

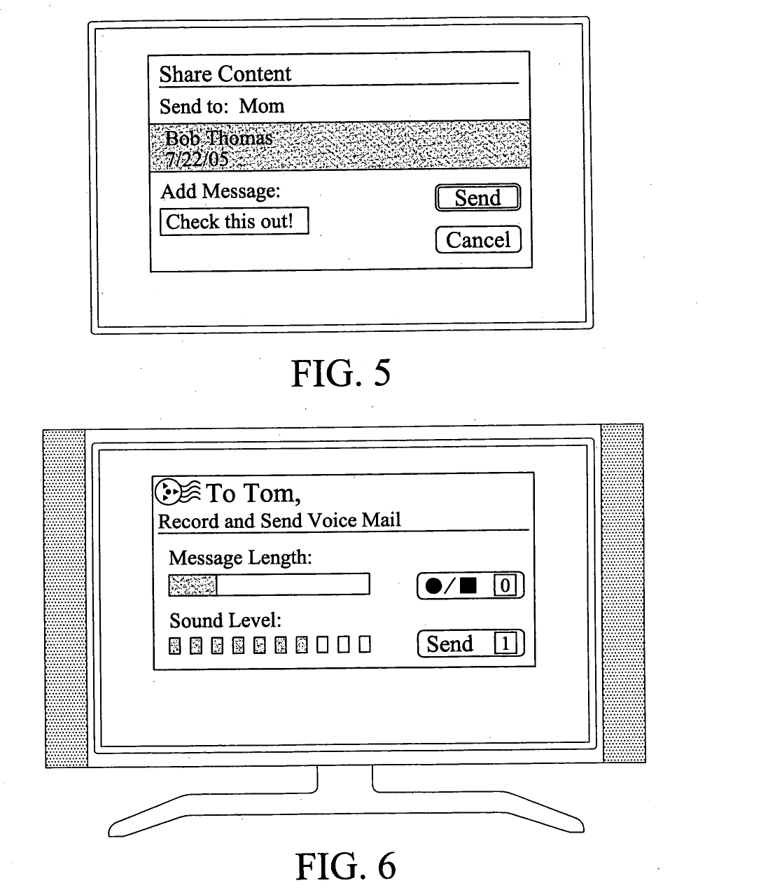

When the user is receiving live television, he can press a button on the remote control for screen capture. This function causes the current frame shown on the television to be captured and stored. The frame may be stored on any suitable storage medium, such as internal memory (buffered), an internal flash memory, removable memory cards, or a network accessible storage device. The captured image may be compressed using any suitable compression technique, such as JPEG (Joint Pictures Expert Group) or GIF (Graphic Interchange Format). The user may upload the captured image to his private account for later viewing; or the user may share the captured image with friends (on another television or connected device) by using a list similar to the one shown in FIG. 5. A text message may be attached along with the captured screen shot.

The user can enjoy viewing the pictures from a digital camera by interconnecting a storage card containing images with the television. These images may be shared (or stored) with other users the same way as screen captured images are shared (or stored).

Similarly, captured images can be provided to a mobile phone. For example, if an interesting frame appears on the television, such as a baseball image, it can be captured and shared with the user of the mobile phone. Likewise, if a person is traveling, a user can take a picture with the camera phone and send/share the picture with a family member watching television. The user watching the television will be alerted in a manner similar to that shown in FIG. 3.

A user may send a voicemail from their mobile phone or computer to another family member who may be watching the television. The voicemail received by the viewer of the television may be listened to, a reply voicemail may be sent to the sender, using an audio message board service as shown in FIG. 6. The audio message board can record a voicemail using the television's microphone to capture voice from the viewer. Appropriate text can be added along with the voicemail in manner similar to the scenario shown in FIG. 5. Note that the TV program can be viewed at the same time as recording voicemail, if needed (in that case, the television audio tuner may be muted).

Text mail can be sent from any electronic device to the television and the person watching TV can be alerted in a manner similar to the one shown in FIG. 3. A reply can be sent using the standard text entry mechanism used in mobile phones and/or using a template. Likewise, instant messaging may be used between the television viewer and the user of a mobile device or computing device.

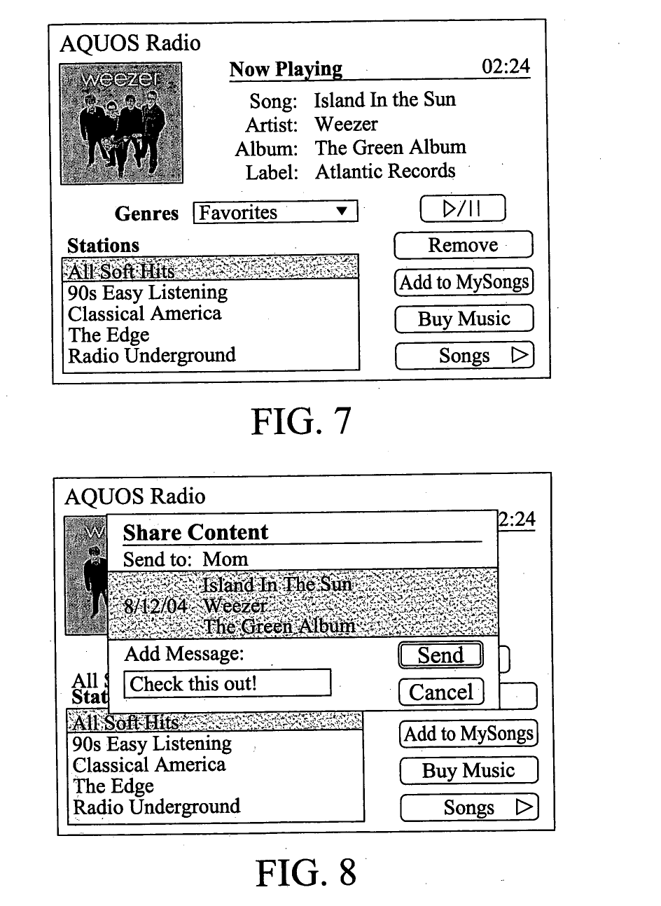

The user may use a radio service provided by the service provider 14 as shown in FIG. 7. In the context of the radio service, the user can bring up a sharing interface as shown in FIG. 8. The sharing module is context-sensitive, in that it can recognize the service against which it was brought up; in this case, it will sense that the background service is radio service, and thus it will make available radio metadata (like song name, artist information, buying parameters, etc.) available for sharing to peer users or storage. A user can provide a text message, for example, “Check out the song xyz by abc” while providing the song if desired. The user may share the song identification code for the song (which may be available as metadata in the radio stream) and alert another user to listen/buy the song. Similarly, if the service is music or video on demand, the sharing module may make the artist information, digital rights for the song, etc., available for sharing with peers. Thus, the depending on the background service against which the sharing module is brought up, the information that is shared varies accordingly.

Other devices may be used to provide video to the television viewer, in a manner similar to voicemail. For example, a mobile phone user can capture a video sequence and send the video to the television. The user will be alerted and the television may then play the video, if desired. Likewise, a user can capture one or more video sequences from the television, send/share the video sequence(s) with other users, and/or stored on a storage medium. While in the context of the video sequences, the same context based sharing module may be used for sharing video clips with peers.

Typically, video mails require greater storage requirements than single images. Hence, usually short clips (with lower resolution) are preferably transmitted as video mails. If the resulting video clip is too big, the user may upload the video to a server and share a link to the video with other users. This link sharing arrangement may likewise be used for image and audio files.

The television may have a connector (e.g., PCMCIA slot or USB connection) into which a user can attach a storage card or other suitable storage device. This permits the user to access the video clips stored in the camera card, which then can be shared with peers in any manner.

While viewing live television, the sharing module may be used to alert another user about a program being displayed on a particular channel. The context sharing module may be used to provide a suitable interface for sharing the content.

It is desirable to be aware beforehand whether the recipient has access/subscribed to the particular channel to be shared. The information may be securely provided to peers. One technique, albeit somewhat cumbersome, to provide secure information is to send emails to all desired peers. A more efficient technique, described below, shares the information more effectively. The user may publish the information in a public folder together with a list of channels to which he has access. This information is preferably encrypted with a symmetric key K_{S} and the key K_{S} is encrypted with the trusted peer's public key. For each trusted user, the encryption of K_{S} is done. The encrypted set of keys can be put together with the encrypted information. If the viewing information changes, then the person updates the (encrypted) information with the same key; if he has to share it with new people he adds the encryption of K_{S} with the new user's public key.

Revocation may be a bit more complicated. The key may be re-encrypted with a new key K_{S} and then encrypting the new key only for non-revoked set of public keys. Revocation may be optional, depending on the system requirements. The same technique may be used for securely sharing media with trusted peers, and is described in more detail below. If the privacy is not important then this information may be published without encryption.

With this framework, the sharing application can check whether the user is allowed to watch a particular channel on his television.

Some users have routers, which will allow the television to be connected to an internal network (e.g., local area network) in addition to an external network (e.g., Internet). This permits accessing content from a laptop and other connected devices. In the embodiment of FIG. 2, the television permits access to the shared media without a requirement for a set-top box. The television may be connected to a home computer home network which permits sharing media (images, video, music) to peers, without the peer having to directly access the shared computer. While in the context of sharing media using the shared computer, the same context based sharing module can be used.

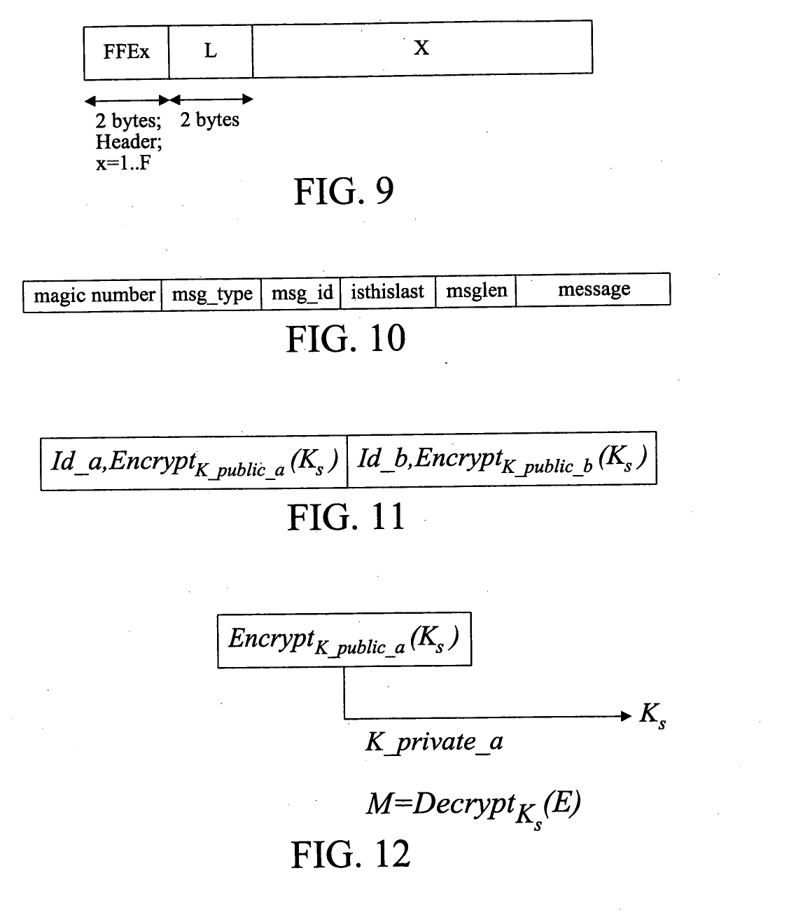

Sharing files is sometimes difficult due to file type requirements that may be imposed by the sharing service. The JPEG standard specifies that headers may have metadata contained therein. Decoders typically ignore general-purpose headers when rendering an image. As an example, one may choose “0xffe5.” For a general purpose header the structure of an exemplary general-purpose header for a JPEG file format is shown in FIG. 9.

The maximum length of such a header for a JPEG compliant file format is L=65536. In the area marked “X” in FIG. 9, packets of information to be shared are inserted sequentially. Packetization may be necessary if the limit of 65536 would be exceeded. The information packets may be pre-pended with suitable custom information-headers, which will aid in conveying the information efficiently. An exemplary information-header is shown in FIG. 10.

The design shown in FIG. 10 facilitates different types of information to be shared in one single image. The field “magic number” denotes the special string that identifies this as an information conveying JPEG header. An example would be to define this as a string, say “SLA_MSG”. The field “msgid” stands for the identification of the information to which this packet pertains. The field “msgtype” stands for the type of information to which this packet pertains. The format may assign, for example, codes as follows:
0: reserved for SMTP headers
1: text
2: voicemail
3: radio meta-data
4: music on demand meta-data
5: video on demand meta-data Etc.

The fields “msgid” and “msgtype” together may convey what type of information packet follows. When coherent packets are ripped and assembled in order, the original information is reconstructed. The field “msglen” denotes the total length of the information for this “msgid” and “msgtype”. The field “isthislast” is redundant since packets can be ripped until all the bytes as dictated by “msglen” are recovered, but it allows the parser at the decoder side to be efficiently implemented. The field “msglen” is repeated in every packet, although not necessary, to simplify the design of the parser engine. There is no requirement to specify the length of the actual message in one packet since that information can be deduced from the encapsulating JPEG header length.

If the information being sent is voicemail, it is likely that the voicemail will not fit in one packet (following one information header). In this case, the encoder may split the total information among many sequential packets.

The code of 0 may be reserved for SMTP headers, denoting “from”, “to”, “subject” fields, etc.; in addition, it can have the optional symmetric key headers, as described below.

The above framework may be used to share information. For example, text messages, voice memos, audio tracks, video, and other data can be located in the JPEG header, which can then be shared as JPEG file. If this JPEG image is shared to peer friends, then the picture-sharing framework may handle sharing the information with trusted peers. However, the images may be uploaded to public folders and then everybody can view the images, but even with this framework, it is possible to protect the embedded information using the mechanism described below. This mechanism allows only images to be uploaded, and that it is used to convey messages to a television. Thus, everyone can see the wrapping image, but only privileged people (e.g., peers) can decipher the embedded message. Also, multiple images can be uploaded for public access also.

When using public access folders for images to upload, the message may be encrypted as follows. Using a key K_{S} will encrypt the original message M to E, as shown below.

E=Encrypt_{K}_{_{S}}(M)

The recipient will decrypt this using the same key K_{S} as shown below. Any standard encryption mechanism can be used, e.g., AES, RC5.

M=Decrypt_{K}_{_{S}}(E)

The K_{S} key should be managed. The key can be generated using any key generation mechanism or a random number generator. To permit access, the system should cryptographically embed K_{S} with the recipient's public key, K_{public}_{_{—}}ₐ (i.e. user a's public key). This embedding in the header may be in the field marked “message”, in FIG. 10. If there are more recipients, K_{S} should be encrypted for each recipient and included in the header. This is illustrated in FIG. 11, for the case where the message is sent to recipients A and B. Id_a is the identification of recipient a. When the recipient receives the message, he can retrieve K_{S} using the corresponding private key Kₚᵣᵢᵥₐₜₑ_{_{—}}ₐ and subsequently the original message as shown in FIG. 12. The private-key public key management is optional, depending on the system configuration. As an alternative, users can set up pair-wise symmetric encryption keys for each user-pair (though this requires a large number of key pairs in the whole system) offline and use these to encrypt K_{S} above. To ensure the public keys are authentic, secondary mechanisms may be relied upon.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A television system for context-based sharing comprising:
(a) a monitor of displaying image data in multiple windows;
(b) a digital data processing module having bidirectional connection to an Internet service provider, mobile phone network and/or computer network;
(c) a television receiver for receiving multimedia inputs including television, radio, data, and/or subscription music;
(d) a context-recognition module for sensing an input medium on one of said multimedia inputs and for determining the type of media provided by said input medium;
(e) a user interface generator for displaying a user interface on said monitor in one of said multiple windows, said user interface having control functions customized to the input medium sensed by the context-recognition module; and
(f) a control device interacting with said user interface to implement said control functions.

2. The television system of claim 1 wherein said user interface provides control functions permitting the capture of media displayed on said television monitor as media data saved to a memory device.

3. The television system of claim 2 wherein said user interface provides control functions permitting the capture of media displayed on said television monitor as media data saved to a network accessible storage location.

4. The television system of claim 1 wherein said control functions include the sending of said media data to peer users.

5. The television system of claim 4 further including a voice input which can be saved to said memory device as media data by one of said control functions.

6. The television system of claim 4 further including an audio input wherein audio data can be saved to said memory device as media data by one of said control functions.

7. The television system of claim 1 wherein said user interface provides control functions permitting the capture of audio and/or voice on said television monitor as media data saved to a network accessible storage location.

8. The television system of claim 4 further including an image-input device wherein images can be saved to said memory device as media data by one of said control functions.

9. The television system of claim 8 wherein said user interface provides control functions permitting the capture of media displayed on said television monitor as media data saved to a network accessible storage location.

10. The television system of claim 4 further including a security-encoding module for encoding said media data prior to transmission to peer users.

11. The television system of claim 1 further including a sharing-service provider and means for converting said media data into a format recognized by said sharing-service provider.

12. The television system of claim 11 further including means for encrypting said media data within said format prior to transmission of said media data to peer users.

13. The television system of claim 11 wherein said context-recognition module receives said input medium and determines the type of said media by meta-data.
